(19) United States
(12) Patent Application Publication
(10) Pub. No.: US 2024/0154237 A1
(43) Pub. Date: May 9, 2024

(54) Structure for Preventing Battery Thermal Runaway, Battery Housing and Battery

(71) Applicant: JIANGSU ZENERGY BATTERY TECHNOLOGIES CO., LTD., Jiangsu (CN)

(72) Inventors: Shengli CHEN, Jiangsu (CN); Zhikang WU, Jiangsu (CN)

(21) Appl. No.: 18/280,943

(22) PCT Filed: Oct. 18, 2021
(86) PCT No.: PCT/CN2021/124354

§ 371 Date: Sep. 8, 2023

(30) Foreign Application Priority Data
May 11, 2021 (CN) 202110508841.3

(51) Int. Cl. H01M 50/325; H01M 50/103

(52) U.S. Cl. CPC H01M 50/325; H01M 50/103

(57) ABSTRACT

Disclosed are a structure for preventing battery thermal runaway, a battery housing and a battery. The structure includes an outer plate and an inner plate, the outer plate and/or the inner plate has a concave portion, the inner plate and the outer plate form an accommodating space accommodating a thermal runaway prevention material in the concave portion; the inner plate has at least one inner hole, the accommodating space has at least one exhaust channel in communication with the inner hole; and a turnover sealing apparatus includes a sealing ring and a turnover sheet, the sealing ring is located between the turnover sheet and the inner plate, the turnover sheet at least partially abuts against the sealing ring, the sealing ring normally seals the exhaust channel, and the turnover sheet turns over at a preset pressure and/or temperature to make the sealing ring unseal the exhaust channel.

### CROSS-REFERENCE TO RELATED APPLICATION

The disclosure claims priority to and the benefit of Chinese Patent Application No. 202110508841.3, filed to the China National Intellectual Property Administration (CHIPA) on 11 May 2021, which is hereby incorporated by reference in its entirety.

### TECHNICAL FIELD

The disclosure relates to the technical field of battery production and manufacturing, and in particularly to a structure for preventing battery thermal runaway, a battery housing and a battery.

### BACKGROUND

Currently, development of environment-friendly and high-efficiency secondary batteries has been encouraged globally. Li-ion battery, as a novel secondary battery, has features of high energy density and power density, high working voltage, light weight, small size, long cycle life, excellent safety, environmental friendliness, etc. Accordingly, it has good prospects for application to portable appliances, power tools, large-sized energy accumulators, electric transportation power supplies, etc.

When the Li-ion power battery has an internal short-circuit under extreme conditions, its temperature will rise sharply, with sparks splashing. Meanwhile, flammable and explosive substances such as electrolyte in the battery will be sprayed out and burn when encountering with oxygen in the environment, and possibly burn the vehicle when spreading through the entire vehicle, which endangers the safety of life and property. In order to prevent disassembly of a cell, an explosion-proof valve is typically arranged on a top cover for directional exhaust in advance. In some cases, an explosion-proof valve is arranged on a housing for directional exhaust in advance. However, since the explosion-proof valve only has an exhaust function, thermal runaway of the cell cannot be effectively prevented.

### SUMMARY

In view of the defects in the related art, an objective of the disclosure is to provide a structure for preventing battery thermal runaway, the structure is able to automatically open an accommodating space upon thermal runaway, and release a thermal runaway prevention material, so as to improve safety of the battery.

In Order to Achieve the Above Objective, the Disclosure Adopts the Following Technical Solutions:

Some embodiments of the disclosure provide a structure for preventing battery thermal runaway, which includes: an outer plate and an inner plate, at least one of the outer plate and the inner plate is integrally or separately provided with a concave portion, the inner plate and the outer plate form an accommodating space in the concave portion, and the accommodating space accommodates a thermal runaway prevention material; and the inner plate is provided with an inner hole, and there is at least one inner hole, the accommodating space is provided with an exhaust channel, and there is at least one exhaust channel, and the exhaust channel is in communication with the inner hole; and a turnover sealing apparatus including a sealing ring and a turnover sheet, the sealing ring is located between the turnover sheet and the inner plate, the turnover sheet corresponds to the inner hole, the turnover sheet at least partially abuts against the sealing ring, the sealing ring seals the exhaust channel in a normal state, and the turnover sheet turns over at a preset pressure and/or temperature, to make the sealing ring unseal the exhaust channel.

In some embodiments, the outer plate is provided with an outer hole corresponding to the inner hole, and the turnover sheet includes a turnover portion, an abutting portion and a welding portion; and the turnover sheet is welded to the outer plate by the welding portion, the turnover portion turns over and deforms at a preset pressure and/or temperature, the abutting portion abuts against the sealing ring in the normal state, and the sealing ring is released when the turnover portion turns over.

In some embodiments, a mounting structure is arranged on the inner plate, the mounting structure is provided with a mounting groove, and the sealing ring is embedded in the mounting groove.

In some embodiments, the mounting structure and the inner plate are formed in an integrated manner or a welded manner.

In some embodiments, a side of the mounting structure towards the outer plate is provided with a boss, and the mounting groove is arranged in a top surface of the boss.

In some embodiments, the mounting structure is provided with a plurality of jaws extending towards the outer plate, and the plurality of jaws are connected to the outer plate in a snap manner; and the exhaust channel is formed between two adjacent jaws of the plurality of jaws.

In some embodiments, a bottom surface of the outer plate is provided with a groove, the inner plate is mounted in the groove for increasing a volume of the accommodating space, an edge of the groove is provided with a step, the step surrounds the groove, and the inner plate is embedded in the step.

In some embodiments, the outer plate or the inner plate is provided with an injection hole, and the injection hole is in communication with the accommodating space.

Some other embodiments of the disclosure provide a battery housing, which is a closed housing, and the battery housing is provided with at least one structure for preventing battery thermal runaway above.

Some still other embodiments of the disclosure provide a battery, which includes a cell and the battery housing above, and the cell is accommodated in the battery housing.

The disclosure has the beneficial effects that the structure for preventing battery thermal runaway includes an outer plate and an inner plate, at least one of the outer plate and the inner plate is integrally or separately provided with a concave portion, the inner plate and the outer plate form an accommodating space in the concave portion, and the accommodating space accommodates a thermal runaway prevention material; and the inner plate is provided with an inner hole, and there is at least one inner hole, the accommodating space is provided with an exhaust channel, and there is at least one exhaust channel, and the exhaust channel is in communication with the inner hole; and a turnover sealing apparatus, which includes a sealing ring and a turnover sheet, the sealing ring is located between the turnover sheet and the inner plate, the turnover sheet corresponds to the inner hole, the turnover sheet at least partially abuts against the sealing ring, the sealing ring seals the exhaust channel in a normal state, and the turnover sheet turns over at a preset pressure and/or temperature, to make the sealing ring unseal the exhaust channel. Since a Li-ion power battery occurs an internal short-circuit under extreme conditions, its temperature will rise sharply, with sparks splashing. Meanwhile, flammable and explosive substances such as electrolyte in the battery will be sprayed out and burn when encountering with oxygen in the environment, and possibly burn a vehicle when spreading through the entire vehicle, which endangers the safety of life and property. In order to prevent disassembly of a cell, an explosion-proof valve is typically arranged on a top cover for directional exhaust in advance. In some cases, an explosion-proof valve is arranged on a housing for directional exhaust in advance. However, since the explosion-proof valve only has an exhaust function, thermal runaway of the cell is not able to be effectively prevented. Therefore, at least one of the outer plate and the inner plate is integrally or separately provided with the concave portion, the inner plate and the outer plate form the accommodating space in the concave portion, the thermal runaway prevention material, for example, a fire retardant and/or a fire extinguishing agent, is injected into the accommodating space, and the accommodating space is provided with the turnover sheet, the sealing ring and the mounting structure, such that the accommodating space forms a closed space. In a normal state, the turnover sheet at least partially abuts against the sealing ring, and the sealing ring seals the exhaust channel, the outer plate and/or the inner plate does not corrode in an electrolyte environment in the cell, the accommodating space does not react with the electrolyte environment in the cell, the thermal runaway prevention material has no influence on the performance of the cell and is also isolated from an external environment, and the thermal runaway prevention material does not leak and dissipate when the cell is used for a long time. When thermal runaway occurs, the turnover sheet in the accommodating space deforms under an influence of a temperature or an internal pressure of the cell, the turnover sheet turns over to release the sealing ring, to form a gap between the turnover sheet and/or the sealing ring and the inner plate, and the exhaust channel is unsealed to release the thermal runaway prevention material outwards from the accommodating space, to retard or extinguish a fire, such that thermal runaway or thermal spread of the cell is prevented. After the turnover sheet deforms, a compression amount of the sealing ring is no longer effectively limited, such that a position of the sealing ring changes from a sealing state to an air-permeable state, and the fire retardant or fire extinguishing agent in the accommodating space diffuses into the cell through the sealing ring, to absorb heat of the cell. Moreover, when an air pressure in the cell continuously increases, a weak portion of the turnover sheet after deformation continuously deforms and tears, and the fire retardant is released into a module space outside the cell simultaneously, to block external oxygen, such that heat spread caused by combustion of high-temperature inflammables sprayed at the explosion-proof valve of the cell is prevented. The disclosure is able to automatically open the accommodating space upon thermal runaway, and release the thermal runaway prevention material, so as to improve safety of the battery.

### BRIEF DESCRIPTION OF THE DRAWINGS

Features, advantages, and technical effects of illustrative embodiments of the disclosure will be described below with reference to the drawings.

FIG. 1 is an unfolded view of a battery housing of the disclosure.

FIG. 2 is a sectional view of Embodiment 1 of the disclosure.

FIG. 3 is an exploded view of Embodiment 1 of the disclosure.

FIG. 4 is a schematic structural diagram of an outer plate according to Embodiment 1 of the disclosure.

FIG. 5 is a schematic structural diagram of an inner plate according to Embodiment 1 of the disclosure.

FIG. 6 is a schematic structural diagram of a mounting structure according to Embodiment 1 of the disclosure.

FIG. 7 is a sectional view of a mounting structure according to Embodiment 1 of the disclosure.

FIG. 8 is a schematic diagram of a turnover sheet in a normal state according to Embodiment 1 of the disclosure.

FIG. 9 is a schematic diagram of a turnover sheet in a thermal runaway state according to Embodiment 1 of the disclosure.

FIG. 10 is a sectional view of a turnover sheet according to Embodiment 1 of the disclosure.

FIG. 11 is a schematic structural diagram of an outer plate according to Embodiment 1 of the disclosure.

FIG. 12 is a sectional view of an inner plate according to Embodiment 2 of the disclosure.

FIG. 13 is a sectional view of an inner plate according to Embodiment 3 of the disclosure.

FIG. 14 is a schematic diagram of a top surface of an enclosed battery housing of the disclosure.

FIG. 15 is a schematic diagram of a bottom surface of an enclosed battery housing of the disclosure.

The reference numerals are illustrated as follows:
1—outer plate; 10—outer hole; 11—groove; 12—extension plate; 111—step;
2—inner plate; 20—inner hole;
3—turnover sheet; 30—sealing ring; 31—turnover portion; 32—abutting portion; 33—welding portion;
4—accommodating space;
6—mounting structure; 61—mounting groove; 62—notch; 63—boss;
7—jaw; 8—recess;
9—injection hole; and
102—exhaust channel.

### DETAILED DESCRIPTION OF THE EMBODIMENTS

Some terms are used throughout the specification and claims to refer to particular assemblies. Those skilled in the art will appreciate that hardware manufacturers may refer to the same assembly by different terms. The specification and claims do not use differences in names to distinguish the assemblies, but rather use differences in functionality to distinguish the assemblies. As used throughout the specification and claims, the words “comprise” and “include” are open-ended words, and thus should be interpreted as “include, but is not limited to”. “Approximately” means that in an acceptable error range, those skilled in the art can solve a technical problem within a certain error range and achieve the technical effect substantially.

Moreover, the terms “first”, “second”, etc. are merely for description and should not be understood as indication or implication of relative importance.

In the disclosure, unless otherwise clearly specified, the terms “mount”, “connect”, “fix”, etc. should be understood in a board sense. For example, connect may be a fixed connection, a detachable connection, an integral connection, a mechanical connection, an electrical connection, a direct connection, or an indirect connection by using an intermediate medium, or may be intercommunication between two components. Those of ordinary skill in the art may understand specific meanings of the foregoing terms in the disclosure based on a specific situation.

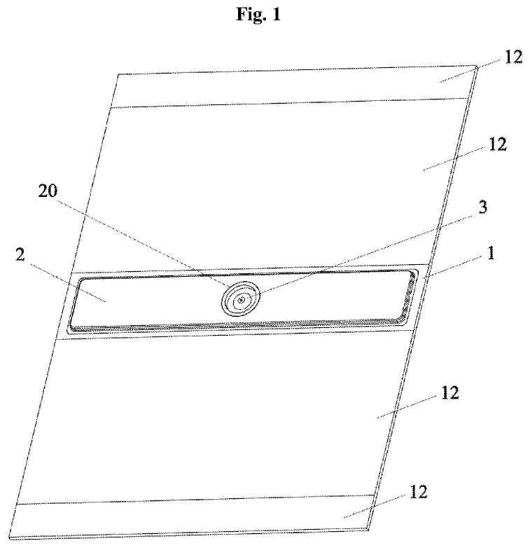

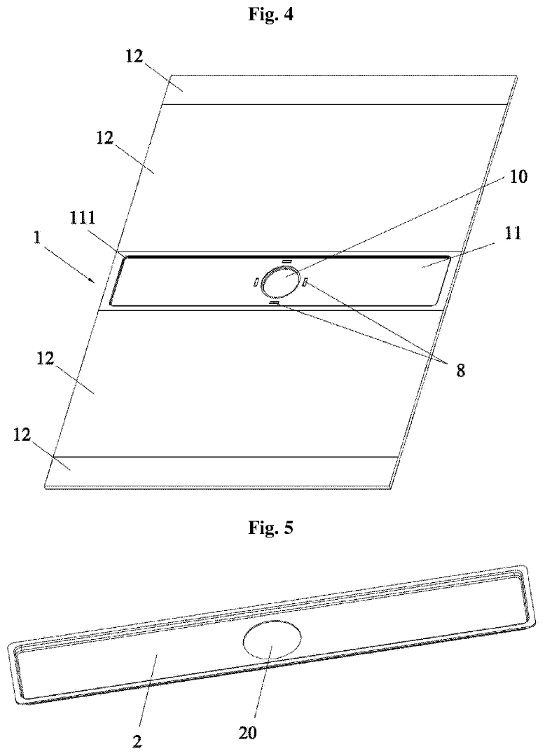

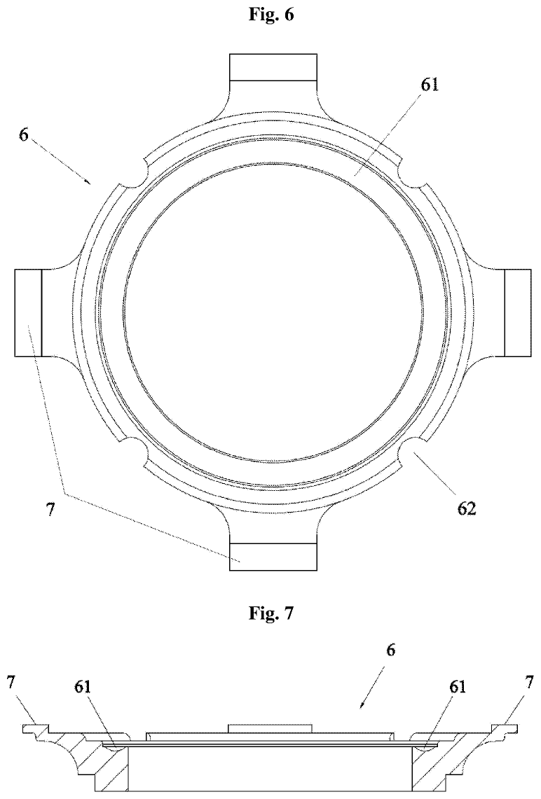

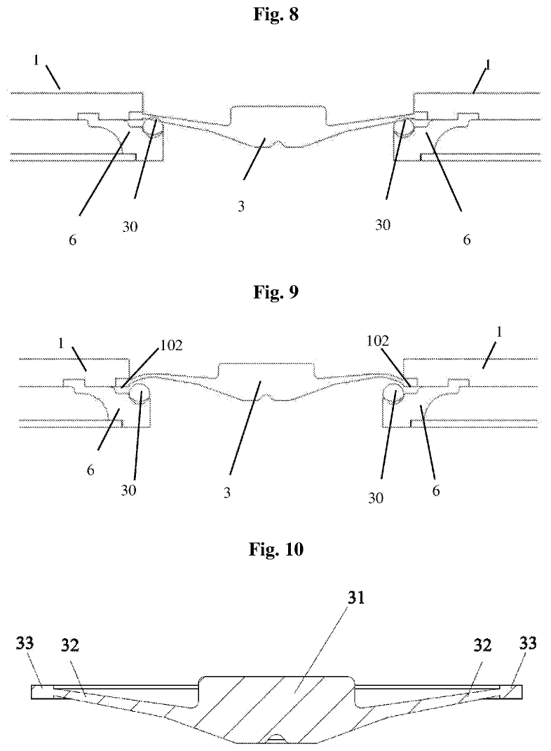

The disclosure will be described in further detail with reference to FIGS. 1-15, which do not limit the disclosure.

### Embodiment 1

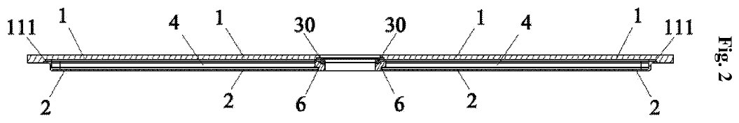

Embodiment 1 is described below in conjunction with FIGS. 2-11.

With reference to FIGS. 2-4, a structure for preventing battery thermal runaway includes: an outer plate 1 and an inner plate 2, at least one of the outer plate 1 and the inner plate 2 is integrally or separately provided with a concave portion, the inner plate 2 and the outer plate 1 form an accommodating space 4 in the concave portion, and the accommodating space 4 accommodates a thermal runaway prevention material; and the inner plate 2 is provided with an inner hole 20, and there is at least one inner hole 20, the accommodating space 4 is provided with an exhaust channel 102, and there is at least one exhaust channel 102, and the exhaust channel 102 is in communication with the inner hole 20; and a turnover sealing apparatus, which includes a sealing ring 30 and a turnover sheet 3, the sealing ring 30 is located between the turnover sheet 3 and the inner plate 2, the turnover sheet 3 corresponds to the inner hole 20, the turnover sheet 3 at least partially abuts against the sealing ring 30, the sealing ring 30 seals the exhaust channel 102 in a normal state, and the turnover sheet 3 turns over at a preset pressure and/or temperature, to make the sealing ring 30 unseal the exhaust channel 102.

Since a Li-ion power battery occurs an internal short-circuit under extreme conditions, its temperature will rise sharply, with sparks splashing. Meanwhile, flammable and explosive substances such as electrolyte in the battery will be sprayed out and burn when encountering with oxygen in the environment, and possibly burn the vehicle when spreading through the entire vehicle, which endangers the safety of life and property. In order to prevent disassembly of a cell, an explosion-proof valve is typically arranged on a top cover for directional exhaust in advance. In some cases, an explosion-proof valve is arranged on a housing for directional exhaust in advance. However, since the explosion-proof valve only has an exhaust function, thermal runaway of the cell is not able to be effectively prevented. Therefore, with reference to FIGS. 1-11, at least one of the outer plate 1 and the inner plate 2 is integrally or separately provided with the concave portion, the inner plate 2 and the outer plate 1 form the accommodating space 4 in the concave portion, a number of the accommodation space 4 is adjusted according to an actual structure of a battery, a thermal runaway prevention material, for example, a fire retardant and/or a fire extinguishing agent, is injected into the accommodating space 4, the turnover sealing apparatus is arranged between the inner plate 2 and the outer plate 1, and the turnover sealing apparatus includes the sealing ring 30 and the turnover sheet 3, such that the accommodating space 4 forms a closed space. In a normal state, the turnover sheet 3 at least partially abuts against the sealing ring 30, the sealing ring 30 seals the exhaust channel 102, the outer plate 1 and/or the inner plate 2 does not corrode in an electrolyte environment in the cell, the accommodating space 4 does not react with the electrolyte environment in the cell, the thermal runaway prevention material has no influence on the performance of the cell and is also isolated from an external environment, and the thermal runaway prevention material does not leak and dissipate when the cell is used for a long time. When thermal runaway occurs, the turnover sheet 3 of the accommodating space 4 deforms under an influence of a temperature or an internal pressure of the cell, the turnover sheet 3 turns over to release the sealing ring 30, to form a gap between the turnover sheet 3 and/or the sealing ring 30 and the inner plate 2, and the exhaust channel 102 is unsealed to release the thermal runaway prevention material outwards from the accommodating space 4, to retard or extinguish a fire, such that thermal runaway or thermal spread of the cell is avoided. After the turnover sheet 3 deforms, a compression amount of the sealing ring 30 is no longer effectively limited, such that the position of the sealing ring 30 changes from a sealing state to an air-permeable state, and the fire retardant or fire extinguishing agent in the accommodating space 4 diffuses into the cell through the sealing ring 30, to absorb heat of the cell. Moreover, when an air pressure in the cell continuously increases, a weak portion of the turnover sheet 3 after deformation continuously deforms and tears, and the fire retardant is released into a module space outside the cell simultaneously, to block external oxygen, such that heat spread caused by combustion of high-temperature inflammables sprayed at the explosion-proof valve of the cell is prevented. The accommodating space 4 includes, but is not limited to, one exhaust channel 102, and the number of the exhaust channel 102 is also able to be adjusted according to an actual structure of a battery, so that when the exhaust channel 102 is in an unsealed state, normal and rapid air leakage is achieved.

In the embodiment, with reference to FIG. 4, the outer plate 1 is a rectangular plate-shaped aluminum profile, a groove 11 and an outer hole 10 are formed in a preset surface by punching and stamping, and a plurality of recesses 8 for welding are arranged around the outer hole 10. The outer plate 1 and the turnover sheet 3 adopt a split-type structure, that is, the turnover sheet 3 is welded to the outer hole 10, and the sealing ring 30 is mounted below the turnover sheet 3. The inner plate 2 is a groove-like structure having an outer edge with a certain height, and the outer edge is connected to the outer plate 1, that is, at least one accommodating space 4 is provided, which does not limit the disclosure. According to an actual mounting position of the turnover sheet 3, the turnover sheet 3 is integrally formed jointly with the outer plate 1, and a relative position of the sealing ring 30 and the turnover sheet 3 is also able to be adjusted. According to actual cost requirements, a periphery of the inner plate 2 and the outer plate 1 is also able to be snap-connected, bonded or rivet-connected to satisfy requirements for the sealing of the accommodating space 4.

The inner plate 2 is provided with an inner hole 20 cooperating with the turnover sheet 3, so that the turnover sheet 3 is subjected to an upward air pressure from the bottom of the inner plate 2 when the battery occurs thermal runaway, and the turnover sheet 3 turns over upward and deforms, the sealing ring 30 rebounds after the deformation and no longer functions to seal the accommodating space 4, and the thermal runaway prevention material in the accommodating space 4 vaporizes under an effect of the temperature, to retard or extinguish a fire of the thermal runaway battery through the exhaust channel 102.

The thermal runaway prevention material includes a fire retardant and/or a fire extinguishing agent. The fire retardant includes, but is not limited to, fluorine-containing hydrocarbons, ketones, etc., which is a non-flammable liquid with a boiling point less than or equal to 80° C. and capable of absorbing heat. The fire extinguishing agent includes, but is not limited to, perfluorohexanone, 2-bromo-3,3,3-trifluoropropene, hexafluoropropane, heptafluoropropane, etc.

In the structure for preventing battery thermal runaway of the disclosure, the outer plate 1 is provided with an outer hole 10 corresponding to the inner hole 20. The turnover sheet 3 includes a turnover portion 31, an abutting portion 32 and a welding portion 33. The turnover sheet 3 is welded to the outer hole 10 by the welding portion 33. The turnover portion 31 turns over and deforms at a preset pressure and/or temperature. The abutting portion 32 abuts against the sealing ring 30 in the normal state, and releases the sealing ring 30 when the turnover portion 31 turns over. In the embodiment, the turnover sheet 3 is divided into the turnover portion 31, the abutting portion 32 and the welding portion 33, the turnover portion 31 is located at the center, the abutting portion 32 is arranged on an outer side of the turnover portion 31, and the welding portion 33 is arranged on an outer side of the abutting portion 32. The turnover sheet 3 is welded to the outer plate 1 by the welding portion 33, so as to fixedly connect the turnover sheet 3 and the outer hole 10. In the normal state, the abutting portion 32 abuts against the sealing ring 30, to seal the exhaust channel 102. When thermal runaway occurs, the turnover portion 31 deforms and turns over under the influence of a temperature or internal pressure of a cell, and moves the abutting portion 32 away from the sealing ring 30, thereby releasing the sealing ring 30 and unsealing the exhaust channel 102.

In the structure for preventing battery thermal runaway of the disclosure, a side of the mounting structure 6 is further provided with a plurality of notches 62 for releasing the thermal runaway prevention material. The plurality of notches 62 penetrate the mounting structure 6. The plurality of notches 62 and a plurality of jaws 7 are arranged in a staggered manner. Specifically, the plurality of notches 62 are arranged on a side edge of the mounting structure 6, and each of the plurality of notches 62 penetrates the mounting structure 6. The turnover sheet 3 partially covers a space above each of the plurality of notches 62. When the turnover sheet 3 turns over and deformed upwards, the thermal runaway prevention material in the accommodating space 4 is able to enter a gap between the turnover sheet 3 and the sealing ring 30 from a periphery of the turnover sheet 3, so as to release the thermal runaway prevention material, and is also able to enter the gap between the turnover sheet 3 and the sealing ring 30 along the plurality of notches 62, so as to increase a release amount of the thermal runaway prevention material released to a thermal runaway cell. A number and size of the plurality of notches 62 are adjusted according to requirements of a size or cost of an actual battery, which is conducive to improving a release efficiency of the thermal runaway material and thus improve the safety of the battery. The plurality of notches 62 and the plurality of jaws 7 are arranged in a staggered manner, so as to avoid a situation that the plurality of jaws 7 block the thermal runaway prevention material and thus influence the release amount of the thermal runaway prevention material.

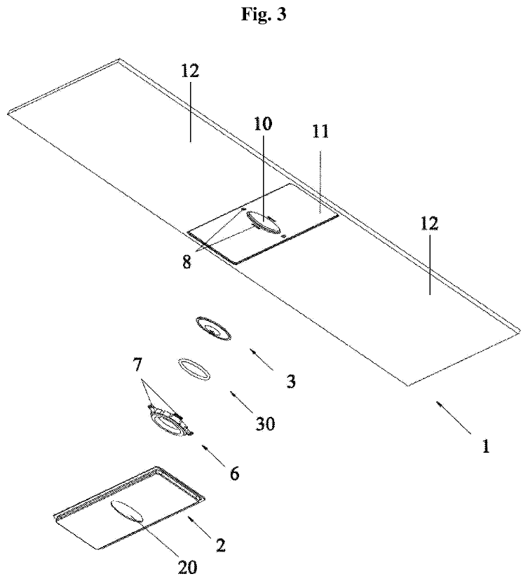

In the structure for preventing battery thermal runaway of the disclosure, with reference to FIG. 3, the outer plate 1 is arranged above the inner plate 2, and the inner plate 2 is provided with the inner hole 20. The turnover sheet 3 is exposed above, in, or below the inner plate 2 by the inner hole 20. The sealing ring 30 is arranged between the turnover sheet 3 and the inner hole 20. In the embodiment, the inner plate 2 is provided with the inner hole 20 cooperating with the sealing ring 30, and the turnover sheet 3 is exposed below the inner plate 2 by the inner hole 20. When the battery occurs thermal runaway, the turnover sheet 3 is subjected to the upward air pressure entering from the inner hole 20, the turnover sheet 3 turns over upward and deforms, the sealing ring 30 rebounds after the deformation and no longer functions to seal the accommodating space 4, the thermal runaway prevention material in the accommodating space 4 vaporizes under the effect of the temperature, and enters a top space of the cell through the gap between the turnover sheet 3 and/or the sealing ring 30 and the inner plate 2, so as to retard or extinguish a fire of the thermal runaway battery. If an internal pressure of the cell continuously increases, a stress concentration is formed at an edge deformation position of the turnover sheet 3, so as to generate a crack, and the thermal runaway prevention material enters a module environment through the crack, so as to reduce a probability that combustion occurs since combustible and explosive gas in the cell is discharged into a module pack through the crack.

In the structure for preventing battery thermal runaway of the disclosure, the inner plate 2 is provided with the mounting structure 6, and the mounting structure 6 is provided with a mounting groove 61. The sealing ring 30 is embedded in the mounting groove 61. The mounting groove 61 is added to accommodate the sealing ring 30. Specifically, the sealing ring 30 is annular, and the mounting groove 61 is also annular, and the sealing ring 30 is embedded in the mounting groove 61, which not only fixes a position of the sealing ring 30, but also is conducive to reducing an entire height of the inner plate 2, such that an entire height of a top cover of the battery is reduced, an internal space of the battery occupied by the top cover of the battery is reduced, and energy density of the battery is further improved. The outer plate 1 and the turnover sheet 3 are of an integrally formed structure, such that a process of welding the turnover sheet 3 to the outer plate 1 is eliminated, which is conducive to reducing an entire production cost of the top cover of the battery, simplifying a production process and improving a production efficiency.

In the structure for preventing battery thermal runaway of the disclosure, with reference to FIGS. 3, 6, and 7, the mounting structure 6 and the inner plate 2 are molded in a welded manner, an end of the mounting structure 6 is fixed to a bottom surface of the outer plate 1, and the other end of the mounting structure 6 is fixed to the inner hole 20. In the embodiment, the mounting structure 6 compresses the sealing ring 30 and is welded to the bottom surface of the outer plate 1. The welding includes, but is not limited to, laser welding. The position of the sealing ring 30 is changed from the sealing state to the air-permeable state by controlling the compression amount of the sealing ring 30. Adding the mounting structure 6 is able to fix the position of the sealing ring 30 in the accommodating space 4, and reduce a probability of displacement or shaking of the sealing ring 30. Specifically, the mounting structure 6 and the outer plate 1 are fixed by welding, and a height of a welding plane controls the compression amount of the sealing ring 30, so as to ensure air tightness inside and outside the sealing ring 30. An inner wall of the inner hole 20 fits with a bottom of the mounting structure 6 in a concave-convex manner. After the concave-convex fit, welding is also performed, which includes, but is not limited to, welding, riveting and bonding, and is preferably soldering, so as to define the position of the mounting structure 6 and reduce the probability of rotating of the mounting structure 6.

In the structure for preventing battery thermal runaway of disclosure, with reference to FIG. 3, the mounting structure 6 is provided with a plurality of jaws 7 extending towards the outer plate 1. The plurality of jaws 7 are connected to the outer plate 1 in a snap manner. The exhaust channel 102 is formed between two adjacent jaws 7 of the plurality of jaws 7. Specifically, a top of the mounting structure 6 extends outwards to form the plurality of jaws 7, that is, clamping portions. The plurality of jaws 7 surround the mounting structure 6. The bottom surface of the outer plate 1 is provided with the plurality of recesses 8 which cooperate with the plurality of jaws 7, that is, buckle portions. The plurality of jaws 7 are integrally formed by the mounting structure 6, or the plurality of jaws 7 are welded to the mounting structure 6. The plurality of jaws 7 cooperate with the plurality of recesses 8 on the bottom surface of the outer plate 1, and the plurality of jaws 7 and the plurality of recesses 8 fit with each other in a concave-convex manner, such that fixed connection between the mounting structure 6 and the outer plate 1 is achieved. Moreover, the sealing ring 30 is in a compressed state and has a certain rebound force, and laser welding printing of the plurality of jaws 7 and the outer plate 1 is able to bear a certain tensile force, so as to avoid separation of the sealing ring 30 or a gap between the sealing ring 30 and the turnover sheet 3 in the normal state, but the disclosure is not limited thereto, according to an actual battery model and cost, the top of the mounting structure 6 is also provided in a different fixed connection mode as long as the mounting structure 6 is prevented from rotating. Furthermore, there is a gap between two adjacent jaws 7 of the plurality of jaws 7, and the thermal runaway prevention material is able to make contact with the sealing ring 30 from the gap. In the normal state, there is no gap between the turnover sheet 3 and the sealing ring 30, to prevent the thermal runaway prevention material from leaking out.

With reference to FIG. 11, in the embodiment, a bottom surface of the outer plate 1 is provided with the groove 11, the inner plate 2 is mounted in the groove 11 for increasing a volume of the accommodating space 4, an edge of the groove 11 is provided with a step 111, the step 111 surrounds the groove 11, and the inner plate 2 is embedded in the step 111. In the embodiment, the inner plate 2 is mounted on the groove 11, and is welded to the outer plate 1 and the mounting structure 6 to form the accommodating space 4. The welding includes, but is not limited to, laser welding. By controlling the compression amount of the sealing ring 30, in a normal use state, the accommodating space 4 is isolated from the inside and the outside of the battery. Specifically, the step 111 is able to limit a position where the inner plate 2 is welded to a cover plate 1, so as to reduce a probability of horizontal displacement of the inner plate 2. Moreover, the step 111 is provided to deepen the groove 11, and a volume of the entire accommodating space 4 is increased within an allowable range of a height of the cover plate 1, such that the accommodating space 4 formed by the cover plate 1 and the inner plate 2 is able to accommodate more thermal runaway prevention material, which is conducive to improvement in effects of retarding and extinguishing a fire by the thermal runaway battery.

In the embodiment, the outer plate 1 or the inner plate 2 is provided with an injection hole 9, and the injection hole 9 is in communication with the accommodating space 4. The thermal runaway prevention material is injected between the outer plate 1 and the inner plate 2 through the injection hole 9, so as to facilitate injection of the thermal runaway prevention material into the accommodating space 4, and further to guarantee an injection efficiency of the thermal runaway prevention material. The number and size of the injection hole 9 are adjusted according to an actual size and production cost of a battery, which does not limit the disclosure. At least one of an outer hole of electrode post and a liquid injection hole is added to the outer plate 1. The outer hole of electrode post is added to fix an electrode post, and a plastic member is arranged between the electrode post and the outer hole of the electrode post, so as to avoid a short circuit caused by direct contact between the electrode post and the outer hole of the electrode post. The liquid injection hole is added to facilitate injection of electrolyte into the battery, the liquid injection hole and an outer liquid injection hole of the inner plate 2 form a liquid injection channel. Specifically, welding of the bottom surface of the outer plate 1 and the outer liquid injection hole allows the electrolyte to directly enter the cell without entering the accommodating space 4 when the cell is injected with liquid, so as to avoid reaction between the electrolyte and the thermal runaway prevention material and an influence of an effect of the thermal runaway prevention material. The injection hole 9 and the liquid injection hole are both provided with sealing nails, which is able to guarantee the tightness of the electrolyte and the thermal runaway prevention material and reduce the possibility of leakage of the electrolyte or the thermal runaway prevention material.

The Working Principle of the Disclosure is:

At least one of the outer plate 1 and the inner plate 2 is integrally or separately provided with the concave portion, the inner plate 2 and the outer plate 1 form the accommodating space 4 in the concave portion, a thermal runaway prevention material, for example, the fire retardant and/or the fire extinguishing agent, is injected into the accommodating space 4, the turnover sealing apparatus is arranged between the inner plate 2 and the outer plate 1, and the turnover sealing apparatus includes the sealing ring 30 and the turnover sheet 3, such that the accommodating space 4 forms a closed space. In the normal state, the turnover sheet 3 at least partially abuts against the sealing ring 30, the sealing ring 30 seals the exhaust channel 102, the outer plate 1 and/or the inner plate 2 does not corrode in the electrolyte environment in the cell, and the accommodating space 4 does not react with the electrolyte environment in the cell, the thermal runaway prevention material has no influence on the performance of the cell and is also isolated from the external environment, and the thermal runaway prevention material does not leak and dissipate when the cell is used for a long time. When thermal runaway occurs, the turnover sheet 3 of the accommodating space 4 deforms under the influence of the temperature or the internal pressure of the cell, the turnover sheet 3 turns over to release the sealing ring 30, to form the gap between the turnover sheet 3 and/or the sealing ring 30 and the inner plate 2, and the exhaust channel 102 is unsealed to release the thermal runaway prevention material outwards from the accommodating space 4, to retard or extinguish the fire, such that thermal runaway or thermal spread of the cell is avoided. After the turnover sheet 3 deforms, the compression amount of the sealing ring 30 is no longer effectively limited, such that the position of the sealing ring 30 changes from the sealing state to the air-permeable state, and the fire retardant or fire extinguishing agent in the accommodating space 4 diffuses into the cell through the sealing ring 30, and absorbs heat of the cell. Moreover, when the air pressure in the cell continuously increases, the weak portion of the turnover sheet 3 after deformation continuously deforms and tears, and the fire retardant is released into the module space outside the cell simultaneously, to block external oxygen, such that heat spread caused by combustion of high-temperature inflammables sprayed at the explosion-proof valve of the cell is avoided.

Parts and the outer plate 1 are assembled together by assembly and welding specifically as follows:
1, welding the turnover sheet 3 to the outer hole 10;
2, mounting the sealing ring 30 below the turnover sheet 3, that is, in an internal direction of a housing;
3, after the mounting structure 6 presses the sealing ring 30, laser-welding the mounting structure 6 to an outer plate 1, to control the compression amount of the sealing ring 30;
4, injecting the thermal runaway prevention material between the outer plate 1 and the inner plate 2; and
5, mounting the inner plate 2 on the outer plate 1, laser-welding the inner plate 2 to the outer plate 1 and the mounting structure 6, to form the accommodating space 4, the accommodating space 4 is isolated from an inside and an outside of the housing by the turnover sealing apparatus.

Other structures are identical to those in Embodiment 1 and are not repeated herein.

### Embodiment 2

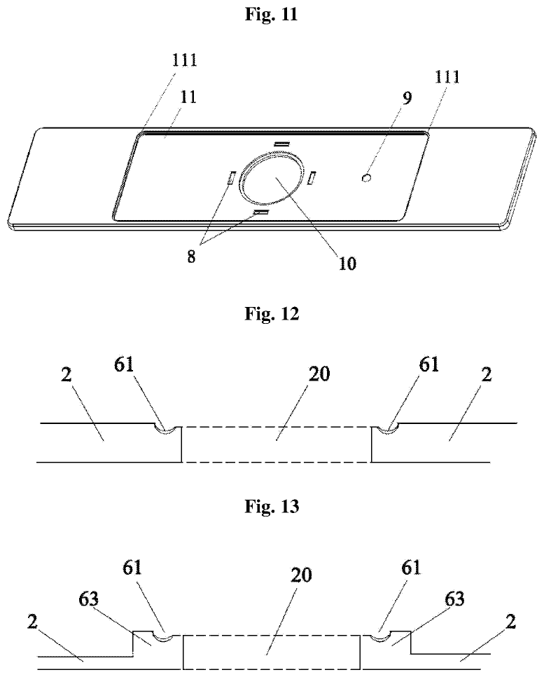

A difference from Embodiment 1 is as follows: with reference to FIG. 12, the mounting structure 6 is integrally formed with the inner plate 2, such that welding the mounting structure 6 to the outer plate 1 is eliminated, which is conducive to reducing the entire production cost of an top cover of the battery, simplifying the production process and improving the production efficiency. Specifically, the inner plate 2 is integrally stamped or extruded to form the mounting structure 6, the inner plate 2 and the mounting structure 6 are made of the same material, which is conducive to reducing the gap between the inner plate 2 and the mounting structure 6, improving entire strength of the inner plate 2 and the mounting structure 6 accordingly, and prolonging the service life of the structure for preventing battery thermal runaway. The mounting structure 6 is a flat surface. The mounting groove 61 is a groove provided in the flat surface, which is conducive to simplifying the production process and reducing the production cost.

Other structures are identical to those in Embodiment 1 and are not repeated herein.

### Embodiment 3

A difference from Embodiment 2 is as follows: with reference to FIG. 13, a side of the mounting structure 6 toward the outer plate 1 is provided with a boss 63, and the mounting groove 61 is arranged on a top surface of the boss 63. According to an actual structure of the battery, the side of the mounting structure 6 toward the outer plate 1 is provided with the boss 63, and the mounting groove 61 is arranged on the top surface of the boss 63. Thus, in the normal state, the abutting portion 32 is able to abut against the sealing ring 30, so as to seal exhaust channel 102, and when thermal runaway occurs, the abutting portion 32 moves away from the sealing ring 30, such that the sealing ring 30 unseals the exhaust channel 102.

Other structures are identical to those in Embodiment 2 and are not repeated herein.

Battery Housing and Battery Manufacturing

The battery housing according to the disclosure includes the structure for preventing battery thermal runaway according to Embodiments 1-3. The battery housing is a closed housing, and the battery housing is provided with at least one structure for preventing battery thermal runaway.

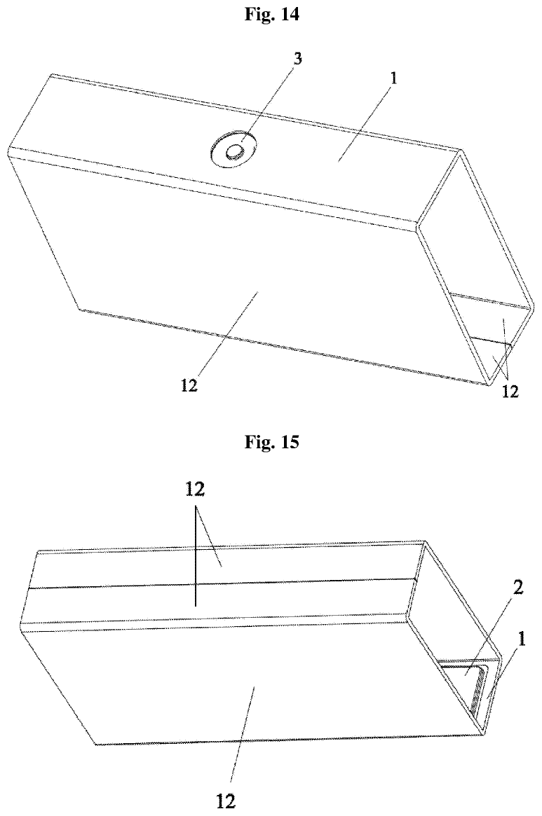

It is to be noted that with reference to FIGS. 14 and 15, at least two ends of the outer plate 1 extend outwards to form an extension plate 12. The extension plate 12 is bent in a desired size to a shape of a preset finished product and welded at a joint to complete production of a finished housing product.

The disclosure further provides a battery. The battery includes a cell and the battery housing described in the foregoing embodiments, and the cell is accommodated in the battery housing.

Variations and modifications can be made to the above embodiments by those skilled in the art according to the disclosure and teachings of the above specification. Therefore, the disclosure is not intended to be limited to the particular embodiments, and the modifications, alterations, and variations based on the disclosure that are apparent to those skilled in the art all fall within the scope of protection of the disclosure. Furthermore, although specific terms are employed herein, they are only used for the convenience of description and do not limit the disclosure in any way.

What is claimed is:

1. A structure for preventing battery thermal runaway, comprising:
an outer plate and an inner plate, at least one of the outer plate and the inner plate is integrally or separately provided with a concave portion, the inner plate and the outer plate form an accommodating space in the concave portion, and the accommodating space accommodates a thermal runaway prevention material; and the inner plate is provided with an inner hole, and there is at least one inner hole, the accommodating space is provided with an exhaust channel, and there is at least one exhaust channel, and the exhaust channel is in communication with the inner hole; and
a turnover sealing apparatus, which comprises a sealing ring and a turnover sheet, the sealing ring is located between the turnover sheet and the inner plate, the turnover sheet corresponds to the inner hole, the turnover sheet at least partially abuts against the sealing ring, the sealing ring seals the exhaust channel in a normal state, and the turnover sheet turns over at a preset pressure and/or temperature, to make the sealing ring unseal the exhaust channel.

2. The structure for preventing battery thermal runaway according to claim 1, wherein the outer plate is provided with an outer hole corresponding to the inner hole, and the turnover sheet comprises a turnover portion, an abutting portion and a welding portion; and
the turnover sheet is welded to the outer plate by the welding portion, the turnover portion turns over and deforms at a preset pressure and/or temperature, the abutting portion abuts against the sealing ring in the normal state, and releases the sealing ring when the turnover portion turns over.

3. The structure for preventing battery thermal runaway according to claim 2, wherein a mounting structure is arranged on the inner plate, the mounting structure is provided with a mounting groove, and the sealing ring is embedded in the mounting groove.

4. The structure for preventing battery thermal runaway according to claim 3, wherein the mounting structure and the inner plate are molded in an integrated manner or a welded manner.

5. The structure for preventing battery thermal runaway according to claim 4, wherein a side of the mounting structure towards the outer plate is provided with a boss, and the mounting groove is arranged in a top surface of the boss.

6. The structure for preventing battery thermal runaway according to claim 3, wherein the mounting structure is provided with a plurality of jaws extending towards the outer plate, and the plurality of jaws are connected to the outer plate in a snap manner; and
the exhaust channel is formed between two adjacent jaws of the plurality of jaws.

7. The structure for preventing battery thermal runaway according to claim 1, wherein a bottom surface of the outer plate is provided with a groove, the inner plate is mounted in the groove for increasing a volume of the accommodating space, an edge of the groove is provided with a step, the step surrounds the groove, and the inner plate is embedded in the step.

8. A battery housing, which is a closed housing, and the battery housing is provided with at least one structure for preventing battery thermal runaway according to claim 1.

9. A battery, comprising a cell and the battery housing according to claim 8, and the cell is accommodated in the battery housing.

10. The structure for preventing battery thermal runaway according to claim 6, wherein a side of the mounting structure is further provided with a plurality of notches for releasing the thermal runaway prevention material, and the plurality of notches and the plurality of jaws are arranged in a staggered manner.

11. The structure for preventing battery thermal runaway according to claim 6, wherein a bottom surface of the outer plate is provided with a plurality of recesses, and the plurality of jaws and the plurality of recesses fit with each other in a concave-convex manner.

12. The structure for preventing battery thermal runaway according to claim 1, wherein the outer plate or the inner plate is provided with an injection hole, and the injection hole is in communication with the accommodating space.

13. The battery housing according to claim 8, wherein the outer plate is provided with an outer hole corresponding to the inner hole, and the turnover sheet comprises a turnover portion, an abutting portion and a welding portion; and
the turnover sheet is welded to the outer plate by the welding portion, the turnover portion turns over and deforms at a preset pressure and/or temperature, the abutting portion abuts against the sealing ring in the normal state, and releases the sealing ring when the turnover portion turns over.

14. The battery housing according to claim 13, wherein a mounting structure is arranged on the inner plate, the mounting structure is provided with a mounting groove, and the sealing ring is embedded in the mounting groove.

15. The battery housing according to claim 14, wherein the mounting structure and the inner plate are molded in an integrated manner or a welded manner.

16. The battery housing according to claim 15, wherein a side of the mounting structure towards the outer plate is provided with a boss, and the mounting groove is arranged in a top surface of the boss.

17. The battery housing according to claim 14, wherein the mounting structure is provided with a plurality of jaws extending towards the outer plate, and the plurality of jaws are connected to the outer plate in a snap manner; and
the exhaust channel is formed between two adjacent jaws of the plurality of jaws.

18. The battery housing according to claim 17, wherein a side of the mounting structure is further provided with a plurality of notches for releasing the thermal runaway prevention material, and the plurality of notches and the plurality of jaws are arranged in a staggered manner.

19. The battery housing according to claim 17, wherein a bottom surface of the outer plate is provided with a plurality of recesses, and the plurality of jaws and the plurality of recesses fit with each other in a concave-convex manner.

20. The battery housing according to claim 8, wherein a bottom surface of the outer plate is provided with a groove, the inner plate is mounted in the groove for increasing a volume of the accommodating space, an edge of the groove is provided with a step, the step surrounds the groove, and the inner plate is embedded in the step.
